(19) United States
(12) Patent Application Publication
(10) Pub. No.: US 2009/0113103 A1
(43) Pub. Date: Apr. 30, 2009

(54) CASCADE TYPE CHARGE ASSEMBLY

(76) Inventor: Han-chung Chiang, Banqiao City (TW)

Correspondence Address: KIRTON AND MCCONKIE, 60 EAST SOUTH TEMPLE,, SUITE 1800, SALT LAKE CITY, UT, 84111, US

(21) Appl. No.: 11/970,960

(22) Filed: Jan. 8, 2008

(30) Foreign Application Priority Data
Oct. 29, 2007 (TW) 096140610

(51) Int. Cl. G06F 13/00

(52) U.S. Cl. 710/301

(57) ABSTRACT

A cascade type charge assembly is provided. The cascade type charge assembly is shaped in an expansion card and can be detached according to different purposes. The cascade type charge assembly comprises at least a first adapter, a second adapter, a third adapter, and a cover. A first type universal serial bus (USB) connecting line is disposed on one side of the first adapter for electrically connecting to a computer, and a second type USB connector is disposed on the other side of the first adapter. The second adapter has a side to be cascaded with the second type USB connector, and at least one cylindrical male plug is disposed on the other of the second adapter. The third adapter has a side to be cascaded with the at least one cylindrical male plug, and an electrical connector disposed on the other side of the third adapter, which can be accommodated within the cover.

### FIELD OF THE INVENTION

The present invention relates to a cascade type charge assembly, and more particularly to a multi-purpose cascade type charge assembly shaped in an expansion card.

### BACKGROUND OF THE INVENTION

Presently, there are various types of portable information devices including, for example, mobile phones, BlackBerry, iPhone, iPod, Motion Picture Expert Group-1 Layer 3 (MP3) players, PlayStation Portables (PSP), Nintendo Dual Screen Lite (NDSL), Portable Media Player (PMP) and so on. Common consumer likely carries at least one portable information device or more. When the portable information devices need to be charged or connected to a computer for data access, the portable information devices can not be charged or access data in convenience even if utilizing the consumer's computer, unless that the consumer carries many kinds of charge assembly or data transmission lines corresponding to the respective portable information devices by himself.

As known, common laptop has a built-in expansion card slot. In early years, the expansion card slot adopts a Personal Computer Memory Card International Association (PCMCIA)-CardBus standard, which is promoted by Personal Computer Memory Card International Association (PCMCIA) in 1990. In 2003, the Personal Computer Memory Card International Association (PCMCIA) contiguously promoted an ExpressCard standard to replace the Personal Computer Memory Card International Association (PCMCIA)-CardBus standard for uses of desktop and laptops. ExpressCard standard has two types including ExpressCard/34 and ExpressCard/54, which has become a common standard for new-generation laptops. Actually, laptops made after 2005 have disposed with a built-in expansion card slot.

As understood, there are some electronic devices manufactured in the shape of an expansion card which are able to be conveniently accommodated in an expansion card slot of a laptop. For example, a Taiwan issued Patent No. 1289265 discloses a plated keypad and a universal serial bus (USB) connector which are integrally shaped to be accommodated within a PCMCIA expansion card slot. Alternatively, a Taiwan issued Paten No. M292122 discloses that a handwriting board can be accommodated within a PCMCIA expansion card slot.

However, the above-mentioned electronic devices capable of being accommodated in a PCMCIA expansion card slot are merely independent data-input devices, rather than a multiple-interface or multiple-purpose device for use of different information devices. Therefore, it is essential to design a device shaped in PCMCIA expansion card and having multiple interfaces for conveniences on usages of different information devices, like power charge or data access, wherein if out of use, the device can be accommodated within an expansion card slot of a laptop for portability. The problem should be avoided that the consumer must carry the various types necessary charge assembly or data transmission line by himself.

### SUMMARY OF THE INVENTION

In order to solve the above-mentioned disadvantages, an objective of the present invention is to provide a cascade type charge assembly, which is capable of being detached or cascaded to constitute an adapter for charging, transmitting data, or receiving data, corresponding to different kinds of electronic device.

Another objective of the present invention is to provide a cascade type charge assembly in the shape of an expansion card including, for example, an ExpressCard shape or a PCMCIA-CardBus shape. If out of use, the cascade type charge assembly is able to be accommodated within an expansion card slot. If needed to use, the cascade type charge assembly is taken out from the expansion card slot. Therefore, the cascade type charge assembly is convenient for portability of the users.

In order to reach above-mentioned objectives, the cascade type charge assembly of the present invention comprises a first adapter, a second adapter, a third adapter and a cover. A first type universal serial bus (USB) connecting line for electrically connecting to a computer is jointed on one side of the first adapter, and a second type USB connector for electrically connecting to a first electronic device for data transmission or power charge is disposed on the other side of the first adapter.

One side of the second adapter is capable of cascading with the second type USB connector, and at least one cylindrical male plug is disposed on the other side of the second adapter for electrically connecting to a corresponding second electronic device for power charging or data transmission.

One side of the third adapter is capable of cascading with said cylindrical male plug, and an electrical connector is disposed on the other side of the third adapter for electrically connecting to a corresponding third electronic device for power charging or data transmission. The cover is formed with an inner space for accommodating and protecting the electrical connector of the third adapter.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, where:

FIG. 1 is a three-dimensional detachment diagram of a cascade type charge assembly according to one embodiment of the present invention.

FIG. 2 is a three-dimensional portfolio diagram of a cascade type charge assembly according to the embodiment of the present invention.

FIG. 3 is a schematic diagram of a cascade type charge assembly accommodated in an expansion card slot of a laptop.

FIG. 4A, FIG. 4B, and FIG. 4C are respective diagrams representing different portfolios according to the embodiment of the present invention.

FIG. 5 is a diagram showing that an iPod MP3 player is connected through the cascade type charge assembly, to an USB port of a laptop for power charging or data transmitting.

### DETAILED DESCRIPTION OF THE PREFERRED EMBODIMENTS

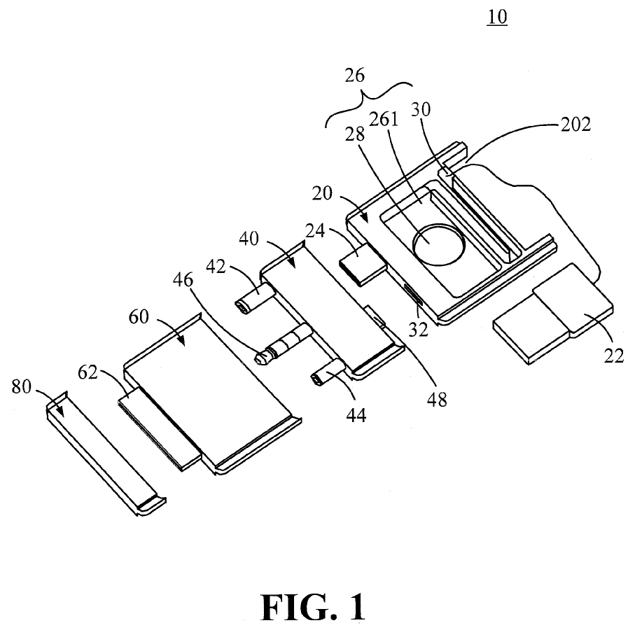

FIG. 1 is a three-dimensional detachment diagram of a cascade type charge assembly according to one embodiment of the present invention, which principally comprises a first adapter 20, a second adapter 40, a third adapter 60, and a cover 80. It is noted that the above-mentioned parts could be cascaded or taken apart for charging or data transmission according to different information devices.

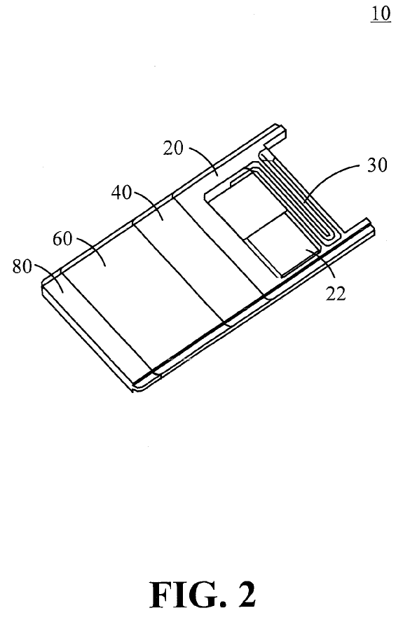

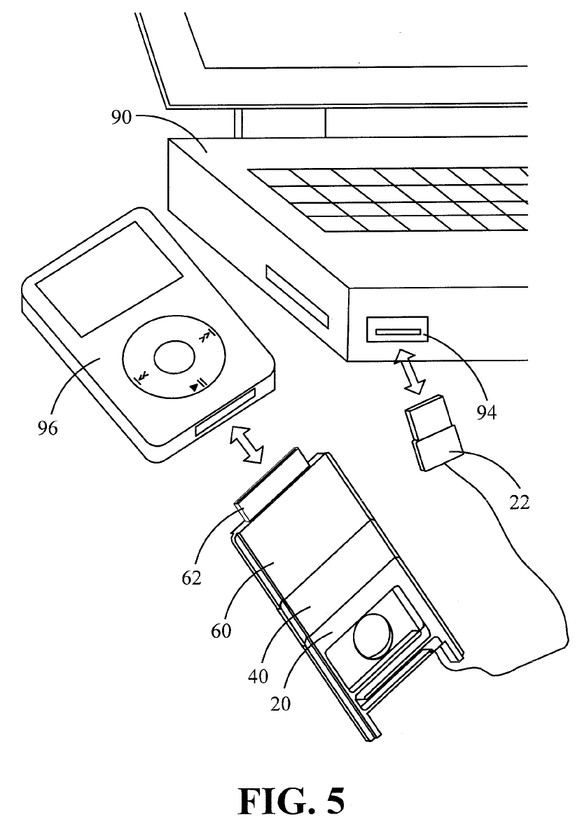

The first adapter 20 is disposed with a first type universal serial bus (USB) connecting line 22 extended from a rear side thereof. In the embodiment, the USB connecting line 22 consists of an A-type USB male connector and a cable for electrically connecting to an USB port 94 of a user's laptop 90 (as shown in FIG. 5). A second type USB connector 24 is disposed on an opposite side of the first adapter 20 for electrically connecting to a corresponding first electronic device (not shown) for power charging or data transmission. The first adapter 20 further comprises a slot 32. In the embodiment, the second type USB connector 24 is implemented as a mini-USB (micro-USB or B-type USB) male connector, and the corresponding first electronic device is as a mobile phone (such as a BlackBerry) having a mini-USB female connector. The first adapter 20 further comprises a containing area 26 and a cavity 202. The containing area 26 comprises a space 261 constituted by a plurality of side walls for accommodating the A-type USB male connector of the USB connecting line 22, a through hole 28 positioned on one of the side walls for taking out the A-type USB male connector of the first type USB connecting line 22 conveniently, and an S-shaped groove 30 for containing and orienting the cable of the first type USB connecting line 22 (as shown in FIG. 2). In other embodiment, the cable could be extended/condensed by a reeling element (not shown) disposed within the containing area 26. The cavity 202 is formed on the same side with the first type USB connecting line 22 and is used for accommodating terminals (not shown) disposed at an end of an expansion card slot 92 of a computer. When the cascade type charge assembly 10 is out of use, the cascade type charge assembly 10 can be inserted into the expansion card slot 92 until completely accommodated within the expansion card slot 92 for convenience on portability. When needs to use, the cascade type charge assembly 10 is taken out by an ejecting button (not shown) which is originally disposed with the expansion card slot 92 as the prior art.

The second adapter 40 comprises a mate connector (not shown) disposed on a rear end thereof and a plurality of different type cylindrical male plugs disposed on the opposite front end. The mate connector is used to correspondingly cascade the second type USB connector 24. In the embodiment, the cylindrical male plugs consist of a first direct current (DC) male plug 42, a second direct current (DC) male plug 44, and a male stereo plug 46 with 4 sections, which are used for electrically connecting to a second electronic device (not shown) for power charging or data transmission. The second electronic device can be implemented as a PlayStation Portable (PSP), a Nintendo Dual Screen Lite (NDSL), a mobile phone, or an iPod-Shuffle. A tenon 48 formed in the same side with the mate connector of the second adapter 40 is used for matching the slot 32 of the first adapter 20 so as to avoid a reverse situation during the first adapter 20 and the second adapter 40 are cascaded with each other.

The third adapter 60 comprises a female plug (not shown) disposed on a rear end thereof and an electrical connector 62 disposed on the opposite front end. The female plug (not shown) is used to match at least one of the cylindrical male plugs. The electrical connector 62 is used to electrically connect with a corresponding third electronic device for power charging or data transmission. In the embodiment, the electrical connector 62 has 40 terminals, two of which are used for data transmission, and another two of the terminals are used for power charging. The third electronic device can be implemented as an iPhone or an iPod 96 (as shown in FIG. 5).

The cover 80 is used for cascading with the third adapter 60 and has an inner space (not shown) for accommodating and protecting the electrical connector 62 of the third adapter 60.

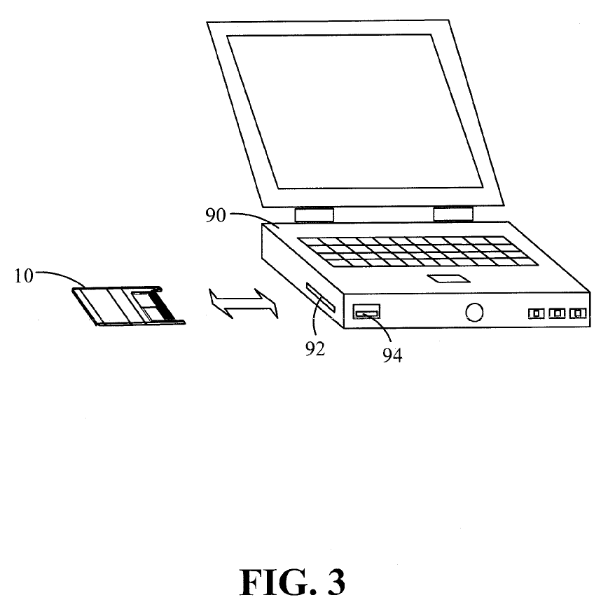

FIG. 2 is a three-dimensional portfolio diagram of the cascade type charge assembly 10, which expresses that the entire structure of the cascade type charge assembly 10 is made in the shape of an expansion card for conforming with a PCMCIA card, a CardBus, or an ExpressCard standard. As the result shown in FIG. 3, when the cascade type charge assembly 10 is out of use, the cascade type charge assembly 10 can be inserted into the expansion card slot 92 until completely accommodated within the expansion card slot 92 for convenience on portability. Oppositely, when any electronic device needs to be charged or transmit data with the laptop 90, the cascade type charge assembly 10 can be taken out from the expansion card slot 92 to electrically interconnect between the electronic device and the laptop 90.

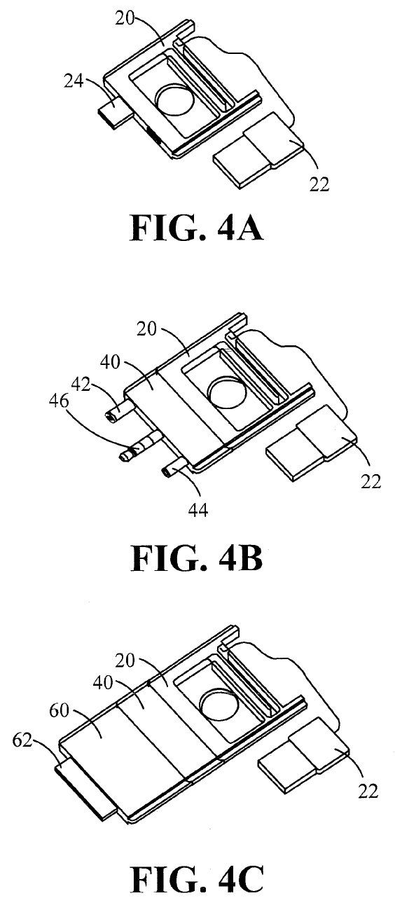

Please further refer to FIGS. 4A to 4C which express different applications for different electronic devices by varying the portfolio of the assembly. In FIG. 4A, if only the first adapter 20 is needed to use, the male connector of the first type USB connecting line 22 is connected to an USB port 94 of the laptop 90 (as shown in FIG. 5). The second type USB connector 24 (such as a mini-USB) is capable of connecting to any mobile electronic device having a mini-USB interface, a micro-USB interface or a B-type USB interface. Therefore, the mobile electronic device can be charged or transmit data with the USB port 94 of the laptop 90 through the first adapter 20.

Please refer to FIG. 4B. When the second adapter 40 is needed to use, the second adapter 40 are firstly cascaded with the first adapter 20. The first type USB connecting line 22 of the first adapter 20 is connected to the USB port 94 of the laptop 90. The first direct current (DC) male plug 42, the second direct current (DC) male plug 44, and the male stereo plug 46 with 4 sections are respectively connected to proper mobile electronic devices. For example, the first direct current (DC) male plug 42 is connected to a PlayStation Portable (PSP), or a Nintendo Dual Screen Lite (NDSL), the second direct current (DC) male plug 44 is connected to a NOKIA mobile phone, and the male stereo plug is connected to an iPod-Shuffle MP3 player. Therefore, the mobile electronic device can be charged or transmit data with the USB port 94 of the laptop 90 through the second adapter 40 and the first adapter 20.

Please refer to FIG. 4C and FIG. 5. When the third adapter 46 is needed to use, the third adapter 60 are cascaded with the first and second adapters 20, 40. The first type USB connecting line 22 of the first adapter 22 is connected to the USB port 94 of the laptop 90. The electrical connector 62 of the third adapter 60 is electrically connected to an iPhone or an iPod (as shown in FIG. 5). In an exemplar shown in FIG. 5, an iPod MP3 player 96 utilizes the cascade type charge assembly 10 to charge or data transmission with the laptop 90, wherein the first adapter 20, the second adapter 40 and the third adapter 60 are cascaded firstly. Then, the iPod MP3 player 96 is connected to the electrical connector 62 and the first type USB connecting line 22 is connected to the USB port 94 of the laptop 90.

The advantages of the present invention mainly include: (a) many kinds of charging connectors and data transmission lines for portable electronic devices are integrated but capable of being assembled or detached on demands; (b) the assembly is able to be shaped in an expansion card which can be completely accommodated within an expansion card slot of a laptop but can be taken out when needed. Accordingly, the present invention has high convenience on portability.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A cascade type charge assembly capable of being detached upon different ways, comprising:
a first adapter having a first type universal serial bus (USB) connecting line disposed on a side of the first adapter for electrically connecting to a computer, and a second type USB connector disposed on the other side of the first adapter for electrically connecting to a corresponding first electronic device for power charging or data transmission;
a second adapter having a side of the second adapter used to be cascaded with the second type USB connector, and at least one cylindrical male plug disposed on the other side of the second adapter for electrically connecting to a corresponding second electronic device for power charging or data transmission; and
a third adapter having a side of the third adapter used to be cascaded with the at least one cylindrical male plug, and an electrical connector disposed on the other side of the third adapter for electrically connecting to a corresponding third electronic device for power charging or data transmission.

2. The cascade type charge assembly of claim 1, wherein the entire structure of the cascade type charge assembly is shaped in an expansion card.

3. The cascade type charge assembly of claim 2, wherein the shape of the expansion card conforms with a Personal Computer Memory Card International Association (PCMCIA) card, a CardBus, or an ExpressCard standard.

4. The cascade type charge assembly of claim 1, wherein the first adapter further comprises:
a containing area for accommodating the first type USB connecting line; and
a cavity for accommodating terminals disposed on an expansion card slot formed on the computer.

5. The cascade type charge assembly of claim 4, wherein the first type USB connecting line includes an A-type male USB connector and a cable.

6. The cascade type charge assembly of claim 5, wherein the containing area comprises:
a space constituted by a plurality of side walls for accommodating the A-type male USB connector;
a through hole positioned on one of the side walls for convenience on taking out the first type USB connecting line; and
a S-shaped groove for accommodating and orientating the cable therein.

7. The cascade type charge assembly of claim 1, wherein the second type USB connector is a mini-USB male connector, a micro-USB male connector, or a B-type male USB connector, and the first electronic device is a mobile phone.

8. The cascade type charge assembly of claim 1, wherein the first adapter further comprises a slot, and the second adapter comprises a tenon for matching with the slot.

9. The cascade type charge assembly of claim 1, wherein the at least one cylindrical male plug comprise at least one direct current (DC) plug and a stereo plug with 4 sections, and the second electronic device is a PlayStation Portable (PSP), a Nintendo Dual Screen Lite (NDSL), a mobile phone or an iPod-Shuffle.

10. The cascade type charge assembly of claim 1, wherein the electrical connector has 40 terminals, and the third adapter is an iPhone or an iPod.

11. The cascade type charge assembly of claim 1, further comprising a cover having an inner space for accommodating the electrical connector of the third adapter.
